(19) United States
(12) Patent Application Publication
(10) Pub. No.: US 2008/0035655 A1
(43) Pub. Date: Feb. 14, 2008

(54) Bucket

(76) Inventor: Michael Baumgartner, Redmond, OR (US)

Correspondence Address: HANCOCK HUGHEY LLP, P.O. BOX 1208, SISTERS, OR, 97759, US

(21) Appl. No.: 11/881,897

(22) Filed: Jul. 30, 2007

Related U.S. Application Data
(60) Provisional application No. 60/836,921, filed on Aug. 10, 2006.

(51) Int. Cl. B65D 25/00

(52) U.S. Cl. 220/751

(57) ABSTRACT

A bucket is preferably injection molded plastic and has a flattened rear wall portion to which first and second spaced apart hooks are attached. The hooks are configured for attaching the bucket to a horizontal bar, such as the rail of a standard stock panel. The height of the bucket is such that the bucket spans the distance between adjacent horizontal rails of a stock panel. The spaced apart hooks also allow the hooks to be attached to a rail on either side of a post. Locking pins in each hook secure the bucket to the panel.

### FIELD OF THE INVENTION

This invention relates generally to buckets, and more particularly to a bucket especially suitable for use with livestock panels for feeding and/or watering livestock, and for use in other situations where the bucket may be hung from and secured to a horizontal rail.

### BACKGROUND

Most livestock owners use buckets of different types to feed and water their animals. Not surprisingly, there are many, many different types and styles of buckets. Similarly, many livestock owners use stock panels in paddocks and corrals to contain their animals. While there are many different kinds of stock panels, most panels have a series of horizontal rails interconnected with vertical posts-welded tubing is typically used to form the posts and rails. A few examples of exemplary stock panels may be found at www.noblepanels.com and www.priefert.com.

When livestock are held in corrals made from panels, feed and/or watering buckets are often tied or chained to one of the rails or posts. Although tying or chaining a bucket to a panel keeps the bucket away from the animal's hooves, it is an inconvenient way to hold the bucket in place since it requires some dexterity to reliably tie or chain the bucket in place. It can also be very difficult to maneuver a heavy bucket to a relatively high rail and tie the handle to the rail.

There are some buckets fitted with hooks that go over a panel rail. However, because the span between panel rails varies according to the manufacturer, and the type of rail, most of these buckets are not capable of spanning between two adjacent rails. Moreover, these buckets may be knocked off the rail, which could lead to damage to the bucket, or injury to the livestock. Some types of livestock are notorious at removing buckets from panels, and if a bucket isn't secured to the rail then it may fall to the ground where it can get tangled in the animal's hooves, frightening or injuring the animal.

There is a need for improved buckets for use in watering and feeding livestock.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a front, side perspective view of a first illustrated embodiment of a bucket according to the present invention, showing the bucket attached to a livestock panel.

FIG. 2 is a perspective view of the bucket of FIG. 1, illustrating the bucket attached to a panel with the bucket hooks spanning a vertical post.

FIG. 3 is a rear view of the bucket shown in FIG. 1.

FIG. 4 is a cross sectional view taken along the line 4-4 of FIG. 3.

FIG. 5 is a rear view of the bucket shown in FIG. 2, illustrating one locking pin completely removed and the other locking pin in place.

FIG. 6 is a bottom perspective view of the bucket shown in FIG. 1.

### DETAILED DESCRIPTION OF THE PREFERRED EMBODIMENTS

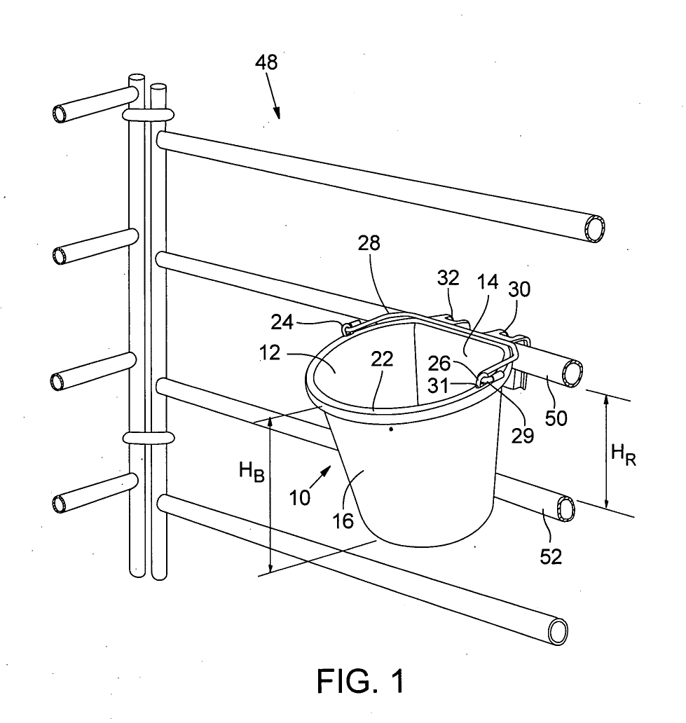

A first preferred embodiment of the bucket 10 of the present invention is shown in FIGS. 1 through 6. Bucket 10 is preferably formed of a durable plastic, and formed by injection molding. As illustrated in the figures and as well known by those of skill in the art, a plastic bucket manufactured with injection molding techniques will include various reinforcing ribs strategically placed around locations where the bucket might be stressed during normal use. The bucket 10 shown in the drawings includes various reinforcing ribs 11 at suitable locations around the bucket; it will be appreciated that additional reinforcement may be desirable depending upon factors such as the wall thickness, the type of plastic, and other considerations. A suitable bucket according to the present invention may also be fabricated from materials other than plastic, such as metal.

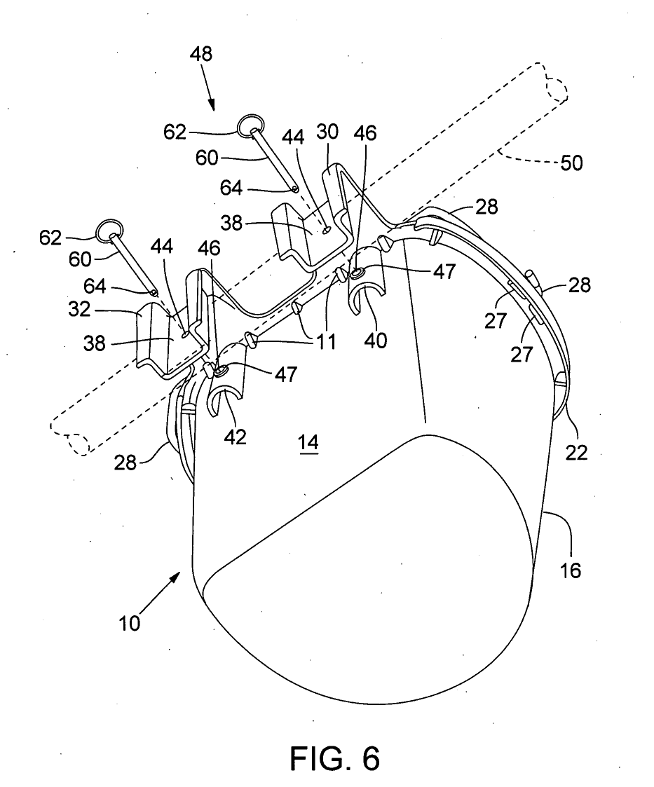

Bucket 10 has an open top 12 defining a relatively large opening that allows livestock to easily access the contents of the bucket. The bucket 10 has a flattened back wall 14 portion and a generally rounded body 18. The bucket body 18 tapers downwardly toward closed base 20 (FIG. 6), so that multiple buckets may be nested for efficient storage. A lip 22 is integrally formed around the periphery of open top 12. Lip 22 adds strength to the bucket, and serves to hold handle retainers 24 and 26, to which the opposite ends of a handle 28 are attached. Handle retainers 24 and 26 are elongate strips of metal wire 27 with a central, upward loop portion 29. As best seen in FIG. 1, the loop portion 29 extends through a slot 31 formed in the lip 22. With reference to FIG. 6, the elongate metal wire 27 extends on the underneath side of lip 22 on either side of slot 31 so that the metal wires 27 cannot be pulled away from the bucket 10.

In FIG. 1 bucket 10 is shown attached to a typical livestock panel 48, and more particularly, with the bucket attached to a horizontal rail 50 of the panel 48. It will be appreciated that the height of bucket 10 measured from the upper edge of lip 22 to the lower edge of the bucket, dimension H_{B} in FIG. 1, is greater than the vertical distance between adjacent rails 50 and 52 in FIG. 1, shown as dimension H_{R} in FIG. 1. As such, when bucket 10 is attached to panel 48 in the manner shown in FIG. 1, the lower portion of the rear of the bucket—that is, at flattened portion 14—rests against the lower rail 52. This manner of attaching the bucket to the panel stabilizes the bucket and keeps it in a desired vertical position even when livestock bang the bucket around. It will be appreciated that when the bucket is hung over rail 50 as in FIG. 1, the lower portion of the bucket tends to swing toward the panel 48 (as shown with arrow A in FIG. 4). Since the lower portions of the bucket hit the rail 52, the bucket cannot swing behind the panel. The vertical dimension of bucket 10 (dimension H_{B}) is sufficient so that the bucket spans the distance between adjacent rails on most commercial stock panels. Although bucket 10 may be made in a variety of sizes and capacities, 14 and 20 quart buckets are typical. And although the rails 50 and 52 are illustrated as cylindrical, it will be appreciated that there are many types of panels on the market, with many different post and rail configurations.

With reference to FIG. 3, bucket 10 includes a pair of hooks 30 and 32, each of which is preferably integrally formed as part of bucket 10 during the injection molding process, and which depend rearwardly from the rear upper edge of the bucket. Each hook 30 and 32 is formed in such a manner that the hooks, although preferably made of the same plastic as the bucket, are quite strong. To this end, each hook includes reinforcing ribs 11 on the upper surface of the hooks near where the hooks join the bucket body. Other reinforcing ribs may also be added, both above and below the hooks. Each hook is further formed with a central trough portion 33 to increase the strength of the hook, and as best illustrated in FIG. 4, trough 33 extends along the descending arm portion 38.

The hooks 30 and 32 each comprise a horizontal arm portion 36 and a downwardly vertically descending arm portion 38. The horizontal arm portion 36 extends from where the hooks join bucket body 18 and extends rearwardly. The length of the horizontal arm portions, and thus the distance between the rear of bucket 10 and the vertically descending arm portions of the hooks, is sufficient that the hooks will accommodate the size of the rails on most commercial stock panels. The downwardly descending arm portions 38 are at about a right angle relative to the horizontal arm portions. Given the nature of the plastic used to mold bucket 10, the vertically descending arms are somewhat “springy”, so that they tend to grip rail 50, yet the hooks are quite resilient and strong. The strength of the hooks and their integral attachment to the body of the bucket may be controlled and regulated by factors such as the thickness of the plastic at various points, use of reinforcing ribs such as ribs 11, and other considerations.

Turning to FIG. 6, a pair of lands 40 and 42 is molded into bucket 10 directly adjacent and beneath hooks 30 and 32, respectively. The lands are defined by elongate semicircular extensions that extend vertically and parallel to the long axis of the downwardly descending arm portions 38 of hooks 30 and 32. The lands also extend outwardly from the flattened back portion 14 of bucket 10 so that there is a space beneath each land and the back portion 14 of the bucket, as best illustrated in the bottom view of FIG. 6. The lands function as surfaces upon which the rail 50 rest when the bucket is attached to the panel (e.g., FIG. 1), and as receptacles for locking pins, as detailed below. The lands are integrally formed with the rest of the bucket during the molding process. While the semicircular shape of the lands shown in the drawings is preferred, the lands may be of other sectional configurations.

A bore 44 is formed in the vertically descending arm portions 38 of both hooks 30 and 32. A corresponding bore 46 is formed in each land 40 and 42 in a position such that the bores 44 in hooks 30 and 32 align with the bores 46 in lands 40 and 42. As detailed below, bores 44 and 46 are designed to accept locking pins 60, which secures the bucket 10 to a panel 48.

When bucket 10 is attached to a stock panel as shown in FIG. 1 with the hooks 30 and 32 placed over rail 50 such that the bucket is hanging on the rail, a locking pin 6 is inserted into each bore 44 and into the corresponding bore 46 in the lands. Each locking pin 60 is preferably a ball lock pin; there are many such pins that are commercially available. Briefly described, a ball lock pin has an elongate shaft with a spring loaded ball near the distal end of the shaft. Because a portion of the ball extends beyond the outer surface of the shaft, the diameter of the shaft is slightly greater at the ball than the diameter of the rest of the shaft. When the pin shaft is inserted into a bore that has a diameter slightly greater than the diameter of the pin shaft, but less than the diameter of the shaft at the ball, the ball is pushed into the shaft against the outwardly directed pressure of the spring, which normally urges the ball to an outward resting position. As the ball is forced inwardly into the shaft, the diameter of the shaft is reduced to thereby allow full insertion of the shaft into the bore. Once the ball passes through the bore, the spring pressure on the ball pushes the ball to its resting position. This effectively increases the diameter of the shaft at the location of the ball, which prevents the pin from being removed from the bore until without some significant force to pull the pin out.

It will be appreciated that in addition to the ball lock type of pins just described and shown in the drawings, other types of pins will suffice, including for example detent pins, retainer pins, clevis pins, toggle pins and the like. Moreover, it is not essential to use a pin having a lock and the bucket may be secured to a horizontal rail without any lock.

Each pin 60 preferably has a pull ring 62 attached to the outer exposed or proximal end to make removal of the pin simple. The opposite end of the pins 60—that is, the end that is inserted into the bore 46 in land 40, includes the spring loaded lock ball 64 (see FIG. 6) that secures the pin in the locked position with the lock ball retained in bore 46 in land 42. The bore 46 may include an optional metallic sleeve 47 that resides in bore 46 to better secure the pin in the bore and to reduce wear between the pin and the bore. As best seen in FIG. 6, the bores 46 are formed in lands 40 and 42 at or near the points of the lands that are closest to the hooks. This part of the lands is spaced apart from the rear flattened portion 14 of bucket 10. Accordingly, when the distal end of a pin 60 is fully inserted into a bore 46, the proximal end of the pin resides in the space between flattened portion 14 and the land. The pin thus does not extend into the bucket itself.

The proximal end of pin 60 includes a ring 62, as noted above. As illustrated in FIG. 4, the length of pin 60 is such that the proximal end of the pin and the ring 62 reside within trough 30. This reduces the risk that an animal or person present on the side of panel 48 opposite bucket 10 will get the pin snagged in, for example, a halter, stable blanket, or in the case of a person, clothing.

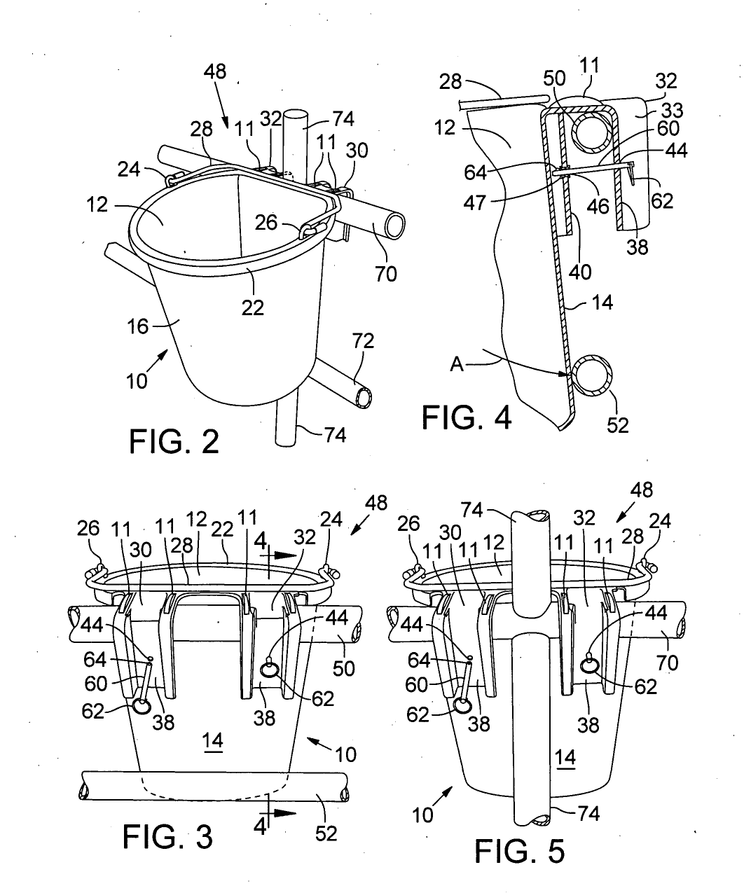

Turning now to FIGS. 2 and 5, in some cases the vertical distance between adjacent rails 70 and 72 on the stock panel is greater than the height of bucket 10. In such a situation, if the bucket were attached only to a horizontal rail as described above, the lower portion of the bucket would be unsecured and so the bucket would swing. In this case, since hooks 32 and 34 are spaced apart, the bucket may be attached to the panel 48 such that one hook 30 is on one side of a post 74, and the other hook 32 is on the opposite side of post 74. Although they are not shown in the front view of FIG. 2, locking pins 60 are used in an identical manner as described above to lock the bucket 10 to the stock panel. Post 74 stabilizes the bucket 10 in a forward and aft direction to prevent it from swinging.

In some cases a stall, paddock or corral will not have stock panels to which bucket 10 such as those described above having hooks 30 and 32 could be attached. In this situation a horizontal bar may be affixed to any wall or surface, and that bar will function identically to a rail on a stock panel and suffice as the attachment point for the bucket 10.

From review of the foregoing in combination with the attached illustrations, it will be appreciated that the bucket according to the present invention provides a container for any objects a person may need to holding. It can be adhered at any height on a stock panel or similar circular rod enclosure/fence. To cite a few examples, the bucket may be used in many marine settings and could be attached to guard railings on a variety of vessels.

In addition to horses and other livestock, the bucket may also be placed low enough on a panel or rod enclosure or fence to feed or water sheep, goats, pigs, chickens, dogs, llamas, alpacas, cows or any other livestock or pet needing such a device.

The invention further provides an animal owner with a safe and easy way to adhere a bucket type container to a panel without the need for any other supplemental devise, such as rope, twine or chain.

It will further be appreciated that there are certain structural variations that may be made to the bucket that are encompassed within the scope of the invention. For example, one or more extension arms may be added to the lower rear portion of the bucket, extending downwardly. If the bucket with extensions were then attached to a panel having rails spaced too far apart for the bucket itself to touch the lower rail, the arms extend downwardly a sufficient distance that the arms contact the lower rail and thereby stabilize the bucket on the panel.

While the present invention has been described in terms of a preferred embodiment, it will be appreciated by one of ordinary skill that the spirit and scope of the invention is not limited to those embodiments, but extend to the various modifications and equivalents as defined in the appended claims.

I claim:

1. A bucket, comprising:
a body having a flattened back wall portion, an open top and closed bottom;
a first hook having a first portion extending away from the body adjacent the open top and a second downwardly extending portion;
a second hook spaced apart from the first hook and having a first portion extending away from the body adjacent the open top and a second downwardly extending portion.

2. The bucket according to claim 1 including a first land between the first hook and the flattened back wall portion and a second land between the first hook and the flattened back wall portion, each land defining a surface spaced apart from a rear wall of the bucket and a space between the surface and the rear wall of the bucket.

3. The bucket according to claim 2 wherein the downwardly extending portion of each hook includes a bore and each land includes a bore that aligns with the bore in the corresponding hook.

4. The bucket according to claim 3 including a pin inserted through the bore in the hook and into the bore in the land, the pin including an end portion that resides in the space between the surface and the rear wall of the bucket.

5. The bucket according to claim 4 including pins inserted through the bores in both hooks and the corresponding bores in both lands.

6. The bucket according to claim 5 in which the pins include retainers for securing the pins in the bores in the lands.

7. The bucket according to claim 6 in which the bores in the lands are lined with a sleeve.

8. The bucket according to claim 7 in which the sleeve is metal.

9. The bucket according to claim 1 wherein the bucket is attached to a stock panel having adjacent horizontal rails, and wherein body has a height that is greater than the distance between the adjacent horizontal rails.

10. The bucket according to claim 1 wherein the bucket is attached to a stock panel having adjacent horizontal rails and a vertical post, and wherein body has a height that is less than the distance between the adjacent horizontal rails.

11. The bucket according to claim 10 in which each hook is located on an opposite side of the vertical post.

12. A bucket configured for removable attachment to a horizontal rail, comprising:
a body having an open top and closed bottom defining an open interior;
a first hook extending away from the body adjacent the open top;
a second hook spaced apart from the first hook and extending away from the body adjacent the open top;
a locking pin for each hook.

13. The bucket according to claim 12 wherein each locking pin extends through a bore in a hook to thereby capture the rail in the hook and prevent removal of the bucket.

14. The bucket according to claim 13 a land formed on the bucket between each of the hooks and the body, each land having a bore aligned with the corresponding bore in the hook and each land having a surface spaced apart from a rear wall of the body and a space between the surface and the rear wall.

15. The bucket according to claim 14 wherein each locking pin has a proximal and distal end, the distal end is inserted into the bore in the land and rests in the space between the surface and the rear wall.

16. The bucket according to claim 15 each hook further defines a rearwardly projecting portion and a downwardly projecting portion, the downwardly projecting portion formed with a recessed trough, and wherein the proximal end of the pin rests in the trough.

17. A bucket configured for attachment to a horizontal rail, comprising:
a body having a flattened back wall portion, an open top and closed bottom to define a bucket interior;
a first hook having a first portion extending away from the body adjacent the open top and a second downwardly extending portion, said first hook having a recessed portion extending along the downwardly extending portion and a bore in the recessed portion;
a second hook spaced apart from the first hook and having a first portion extending away from the body adjacent the open top and a second downwardly extending portion, said second hook having a recessed portion extending along the downwardly extending portion and a bore in the recessed portion;
a first land on the body inwardly of the first hook, said first land having a bore aligned with the bore in the recessed portion in the first hook;
a second land on the body inwardly of the second hook, said second land having a bore aligned with the bore in the recessed portion in the second hook;
a first retaining pin having proximal and distal ends, said first retaining pin extending through the bore in the first hook and into the bore in the first land such that the distal end extends through the land and the proximal end resides in the recessed portion;
a second retaining pin having proximal and distal ends, said second retaining pin extending through the bore in the second hook and into the bore in the second land such that the distal end extends through the land and the proximal end resides in the recessed portion.

18. The bucket according to claim 17 wherein the first and second retaining pins define locking means for locking the bucket to the horizontal rail.

19. The bucket according to claim 18 wherein the retaining pins further include retaining means for releasably securing the retaining pins to the buckets.

20. The bucket according to claim 19 attached to a panel having a vertical post, wherein each hook is positioned over the horizontal rail and each hook is positioned on opposite sides of the vertical post.
